(19) United States
(12) Patent Application Publication
(10) Pub. No.: US 2025/0331455 A1
(43) Pub. Date: Oct. 30, 2025

(54) METHODS AND SYSTEMS FOR NON-CROP OBJECT DETECTION

(71) Applicant: DEERE & COMPANY, MOLINE, IL (US)

(72) Inventors: SCOTT N. CLARK, Bettendorf, IA (US); DUANE M. BOMLENY, Geneseo, IL (US); JUSTIN C. FREEHILL, Fenton, IL (US); SCOTT E. FAULKNER, Orion, IL (US); NATHAN R. VANDIKE, Geneseo, IL (US); NATHAN E. KREHBIEL, Bettendorf, IA (US)

(21) Appl. No.: 18/650,996

(22) Filed: Apr. 30, 2024

(51) Int. Cl. A01D 41/127; G06V 20/56; G06V 20/64

(52) U.S. Cl. CPC A01D 41/127; G06V 20/56; G06V 20/64

(57) ABSTRACT

Example apparatuses systems and methods are provided herein. In some examples, a system or method may be provided to determine a presence of one or more objects disposed in of a portion of an agricultural field disposed about a vicinity of a header of the work machine, determine one or more features of the one or more objects, determine whether the one or more objects are desired objects based at least in part on the one or more features of the one or more objects, determine one or more object identifiers of the one or more objects, and transmit instructions to one or more systems to adjust performance of the agricultural machine based at least in part on the one or more object identifiers.

### FIELD OF THE INVENTION

The present application relates to systems for determining operational conditions for a grain harvesting machine.

### BACKGROUND

Various agriculture work vehicles perform a wide variety of agricultural operations such as, for example, combines and windrowers harvesting a variety of different crops. Depending on the crop or other factors, headers used to harvest the crop may have significantly different geometries, crop engagement, and severing devices. Examples of header platforms may include a rotary mower conditioner and a draper.

### SUMMARY

Example apparatuses systems and methods are provided herein. In some examples, a system may be provided for monitoring a portion of an agricultural field during operation of an agricultural work machine. The system may include one or more processors. The system may include one or more sensors configured to transmit sensor data to the one or more processors. The system may include a memory device coupled to the one or more processors, the memory device including instructions that when executed by the at least one or more processors cause the one or more processors to, determine a presence of one or more objects disposed in of a portion of an agricultural field disposed about a vicinity of a header of the work machine, determine one or more features of the one or more objects, determine whether the one or more objects are desired objects based at least in part on the one or more features of the one or more objects, determine one or more object identifiers of the one or more objects, and transmit instructions to one or more systems to adjust performance of the agricultural machine based at least in part on the one or more object identifiers.

In some examples, a method is provided for monitoring a portion of an agricultural field during operation of an agricultural work machine. The method may include receiving data from one or more sensors. The method may include determining a presence of one or more objects disposed in of a portion of an agricultural field disposed about a vicinity of a header of the work machine. The method may include determining one or more features of the one or more objects. The method may include determining whether the one or more objects are desired objects based at least in part on the one or more features of the one or more objects. The method may include determining one or more object identifiers of the one or more objects. The method may include transmitting instructions to one or more systems to adjust performance of the work machine to based at least in part on the one or more object identifiers.

### BRIEF DESCRIPTION OF THE DRAWINGS

FIG. 1 is a schematic left side elevation view of a grain harvesting machine.

FIG. 2 is schematic illustration of a control system of the grain harvesting machine of FIG. 2.

FIG. 3 is a right side elevation view of a work machine including optical sensors.

FIG. 4 is a flow chart showing example steps for monitoring a portion of an agricultural field.

FIG. 5 is a flow chart showing example steps for monitoring a portion of a work machine.

### DETAILED DESCRIPTION

When operating a work machine such as a grain harvesting machine, it is desirable to determine what objects may pass through and/or below the work machine. It is also desirable to determine the condition of one or more portions of the work machine. Accurate detection of objects such as non-crop objects and machine conditions such as wear may be beneficial to accurately and timely adjust work machine operation. The present disclosure relates to detection systems for detecting non-crop objects and work machine conditions such as wear or damaged components.

One problem that has been encountered in prior image-based systems for detecting non-crop objects and wear is detecting objects within a close vicinity of the work machine (e.g., directly in front of the work machine, at, in, or behind a combine header). Some objects may arise or may be detectable just before interaction with the combine header and/or the combine. One other problem that has been encountered in prior image-based systems is detection of a machine condition of certain portions of work machine may be missed through traditional monitoring means.

The present disclosure provides example detection systems that may include image-based detection aspects for detecting non-crop objects and work machine conditions. By providing one or more sensors such as optical sensors in conjunction with other aspects of the detection systems, the work machine may monitor and detect objects and conditions that may otherwise not be detected.

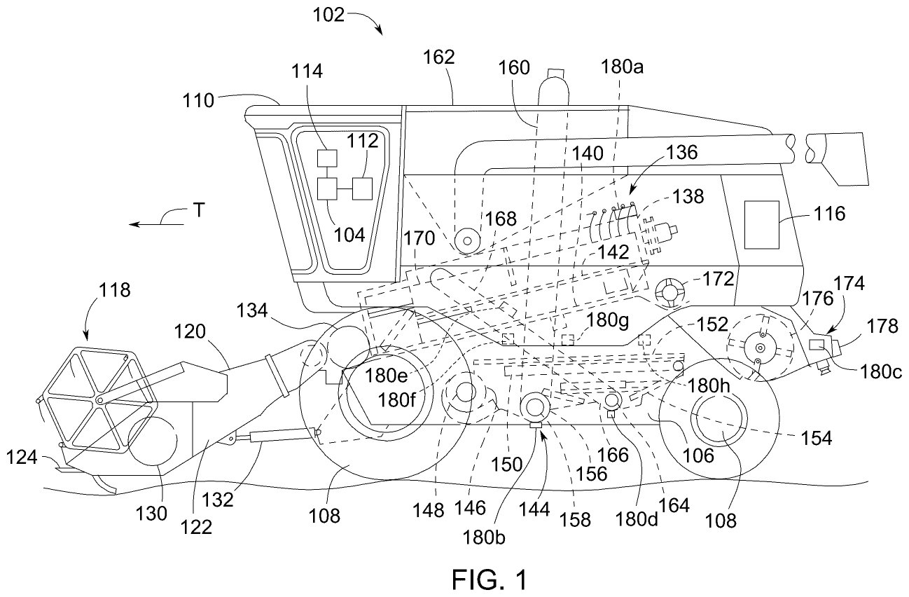

Referring now to FIG. 1, a work machine that is a grain harvesting machine 102 in the form of a combine harvester is shown. The grain harvesting machine 102 includes a controller 104 that controls and/or facilitates operation of various aspects of the grain harvesting machine 102.

As shown, the example grain harvesting machine 102 includes a chassis 106 with ground-engaging wheels 108 or tracks. The wheels 108 are rotatably mounted to the chassis 106 and engage with the ground to propel the grain harvesting machine 102 in a travel direction T. An operator's cab 110, also mounted to the chassis 106, houses an operator as well as various devices to control the grain harvesting machine 102, such as one or more operator input devices 112 and/or display devices 114, further described below.

The wheels 108 and other devices of the grain harvesting machine 102 are powered by an internal combustion engine 116 or other power source.

The engine 116 may be operated based on commands from the operator and/or the controller 104.

A header 118 is mounted at the front of the chassis 106 of the grain harvesting machine 102 to cut and gather crop material from a field. The header 118 is supported by a feederhouse 120 pivotally mounted to the chassis 106. The header 118 includes a frame 122 supporting a cutter bar 124 that extends substantially across the length of the header 118 and that functions to cut crops along the ground. The header 118 may further include a mechanism for collecting the cut material from the cutter bar 124. In this example, the header 118 includes an auger 130 to transport the cut crop material towards the center of the header 118. Other examples may include one or more conveyors. The header 118 may include a header actuator 132 that functions to reposition the header 118 relative to the ground and/or in front and rearward directions. The feederhouse 120 may include, for example, an inclined conveyor (not shown) to transport cut crop material from the header 118 into the body of the grain harvesting machine 102.

After passing over a guide drum or feed accelerator 134, the crop material from the feederhouse 120 reaches a generally fore-aft oriented threshing device or separator 136. Other embodiments may include laterally oriented or other threshing devices (not shown). In the embodiment depicted, the separator 136 includes a rotor 138 on which various threshing elements are mounted. The rotor 138 rotates above one or more grated or sieved threshing baskets or concaves 140, such that crop material passing between the rotor 138 and the concaves 140 is separated, at least in part, into grain and chaff (or other “material other than grain” (MOG)). The concaves 140 may be opened and/or closed with one or more concave actuators 142 (schematically shown). The concave actuators 142, as well as further actuators associated with the concaves 140, may be operated based on commands from the operator and/or the controller 104. The MOG is carried rearward and released from between the rotor 138 and the concaves 140. Most of the grain (and some of the MOG) separated in the separator 136 falls downward through apertures in the concaves 140.

Agricultural material passing through the concaves 140 falls (or is actively fed) into a cleaning subsystem (or cleaning shoe) 144 for further cleaning. The cleaning subsystem 144 includes a fan 146, driven by a motor 148, that generates generally rearward air flow, as well as a sieve 150 and a chaffer 152. The sieve 150 and the chaffer 152 are suspended with respect to the chassis 106 by an actuation arrangement 154 that may include pivot arms and rocker arms mounted to disks (or other devices). As the fan 146 blows air across and through the sieve 150 and the chaffer 152, the actuation arrangement 154 may cause reciprocating motion of the sieve 150 and the chaffer 152 (e.g., via movement of the rocker arms). The combination of this motion of the sieve 150 and the chaffer 152 with the air flow from the fan 146 generally causes the lighter chaff to be blown upward and rearward within the grain harvesting machine 102, while the heavier grain falls through the sieve 150 and the chaffer 152 and accumulates in a clean grain trough 156 near the base of the grain harvesting machine 102.

A clean grain auger 158 disposed in the clean grain trough 156 carries the material to the one side of the grain harvesting machine 102 and deposits the grain in the lower end of a clean grain elevator 160. The clean grain lifted by the clean grain elevator 160 is carried upward until it reaches the upper exit of the clean grain elevator 160. The clean grain is then released from the clean grain elevator 160 and falls or is deposited into a grain tank 162.

Most of the grain entering the cleaning subsystem 144, however, is not carried rearward, but passes downward through the chaffer 152, then through the sieve 150. Of the material carried by air from the fan 146 to the rear of the sieve 150 and the chaffer 152, smaller MOG particles are blown out of the rear of the grain harvesting machine 102. Larger MOG particles and grain are not blown off the rear of the grain harvesting machine 102, but rather fall off the cleaning subsystem 144.

Heavier material carried to the rear of the chaffer 152 exits out of the grain harvesting machine 102. Heavier material carried to the rear of the sieve 150 falls onto a pan and is then conveyed by gravity downward into a grain tailings trough 164 in the form of “tailings,” typically a mixture of grain and MOG. A tailings auger 166 disposed in the tailings trough 164 carries the grain tailings to a side of the grain harvesting machine 102 and into a grain tailings elevator 168. The grain tailings elevator 168 communicates with the tailings auger 166 at an inlet opening of the grain tailings elevator 168 where grain tailings are received for transport for further processing. At a top end of the tailings elevator 168, an outlet opening (or other offload location) 170 is provided (e.g., for return to the thresher).

In a passive tailings implementation, the grain tailings elevator 168 carries the grain tailings upward and deposits them on a forward end of the rotor 138 to be re-threshed and separated. A discharge beater 172 is provided for discharging material from the rotor 138. The now-separated MOG is released behind the grain harvesting machine 102 to fall upon the ground in a windrow or is delivered to a residue subsystem 174 that can include a chopper 176 and a spreader 178 to be chopped by the chopper 176 and spread on the field by the spreader 178. Alternatively, in an active tailings implementation, the grain tailings elevator 168 may deliver the grain tailings upward to an additional threshing unit (not shown) that is separate from the separator 136 and where the grain tailings are further threshed before being delivered to the main crop flow at the front of the cleaning subsystem 144.

The grain harvesting machine 102 may include one or more image capture sensors 180 arranged at one or more image capture areas within or about the grain harvesting machine 102. In addition to aspects described below, each image capture sensor 180 is arranged to capture images of a crop material flow in the respective image capture area of the grain harvesting machine 102. These images may be processed by the controller 104 as further described below, to measure the determine objects in an agricultural field or to monitor work machine condition. Each image capture sensor 180 may be any suitable sensor type, including radar sensors, camera sensors, LiDAR sensors, infrared sensors, near infrared sensors and any other sensor suitable for providing images for spectral analysis.

There are multiple suitable locations within the grain harvesting machine 102 for location of the image capture sensors 180. Some of these are schematically shown in FIG. 1, with various specific locations identified by a suffix “a”, “b”, etc. It is noted that the locations are only generally shown. Within any given area of the machine the image capture sensor should be located and oriented so that it best views a moving air stream of air and entrained grain and MOG. Some locations may be for the purpose of evaluating grain quality at the location. Other locations may be for the purpose of evaluating grain loss. Some locations may be relevant to both grain quality and grain loss.

In a first example an image capture sensor 180a may be located in the area of the threshing device or separator 136. Data from sensor 180a may be representative of grain quality in the area of the sensor 180a, particularly if located in the upstream portions of the threshing device or separator 136. Data from sensor 180a may be representative of grain loss to the residue system if the sensor 180a is located on the downstream end of the threshing device or separator 136.

In another example an image capture sensor 180b may be located in the area of the cleaning shoe 144. Data from sensor 180b in the area of the cleaning shoe may be representative of grain quality of the finished separated grain product.

In a further example an image capture sensor 180c may be located in the area of the residue processing subsystem 174. Data from sensor 180c may be representative of grain loss through the residue processing subsystem 174.

In a still further example, an image capture sensor 180d may be located in the area of the tailings handling system 164, 166 or in location 180e further along the grain tailings elevator 168. Data from sensors 180d or 180e may be representative of grain quality at those locations.

Further image capture sensors may be located at locations 180f, 180g and 180h at various locations successively downstream in the area above the sieve 150 and chaffer 152. The more upstream of those locations may provide data representative of grain quality at those locations. The more downstream of these locations may provide data representative of potential grain loss out the back of the machine 10 with the stream of chaff being blown out of the machine.

### Control System

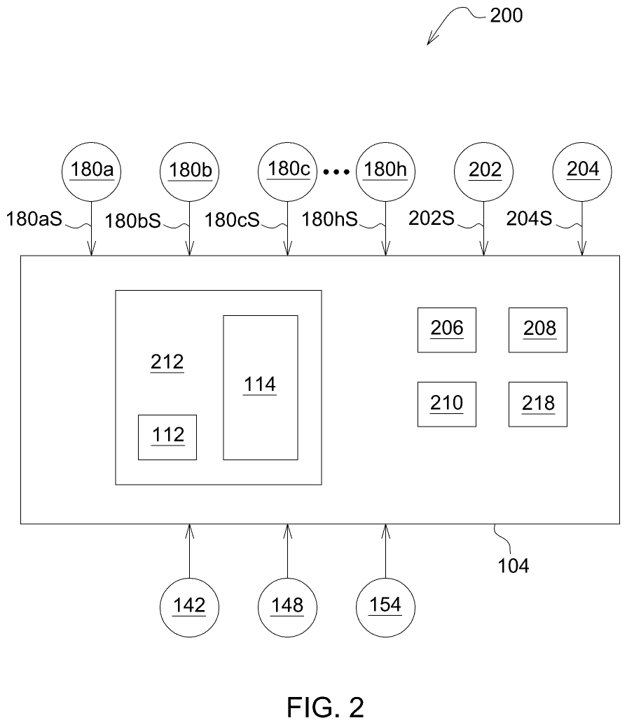

As schematically illustrated in FIG. 2, the grain harvesting machine 102 includes a control system 200 including the controller 104. The controller 104 may be part of the machine control system of the grain harvesting machine 102, or it may be a separate control module. The controller 104 may for example be mounted in a control panel located at the operator's station 110. Controller 104 is configured to receive input signals from the various sensors. The signals transmitted from the various sensors to the controller 104 are schematically indicated in FIG. 2 by lines connecting the sensors to the controller with an arrowhead indicating the flow of the signal from the sensor to the controller 104.

For example, image signals 180aS-180hS from the image capture sensors 180a-180h will be received by controller 104. Controller 104 may also receive a fan speed signal 202S from the fan speed sensor 202 associated with the fan 146. Controller 104 may also receive an air speed signal 204S from the air speed sensor 204 which may be disposed in the grain harvesting machine 102 adjacent any one or more image capture areas. There may be multiple air speed sensors 204 throughout the grain harvesting machine 102.

Similarly, the controller 104 will generate control signals for controlling the operation of various actuators of the grain harvesting machine 102. Those actuators may for example be associated with various subsystems of the grain harvesting machine which affect the grain loss within the machine. Those actuators may include for example, the concave actuators 142, the fan motor 148, and the actuation arrangement 154 associated with the sieve 150 and chaffer 152, just to name a few.

Controller 104 includes or may be associated with a processor 206, a computer readable medium 208, a data base 210 and an input/output module or control panel 212 having the previously mentioned display 114. The previously mentioned input/output device 112, such as a keyboard, joystick or other user interface, is provided so that the human operator may input instructions to the controller. It is understood that the controller 104 described herein may be a single controller having all of the described functionality, or it may include multiple controllers wherein the described functionality is distributed among the multiple controllers.

Various operations, steps or algorithms as described in connection with the controller 104 can be embodied directly in hardware, in a computer program product 218 such as a software module executed by the processor 206, or in a combination of the two. The computer program product 218 can reside in RAM memory, flash memory, ROM memory, EPROM memory, EEPROM memory, registers, hard disk, a removable disk, or any other form of computer-readable medium 208 known in the art. An exemplary computer-readable medium 208 can be coupled to the processor 206 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The data storage in computer readable medium 208 and/or database 210 may in certain embodiments include a database service, cloud databases, or the like. In various embodiments, the computing network may comprise a cloud server, and may in some implementations be part of a cloud application wherein various functions as disclosed herein are distributed in nature between the computing network and other distributed computing devices. Any or all of the distributed computing devices may be implemented as at least one of an onboard vehicle controller, a server device, a desktop computer, a laptop computer, a smart phone, or any other electronic device capable of executing instructions. A processor (such as a microprocessor) of the devices may be a generic hardware processor, a special-purpose hardware processor, or a combination thereof.

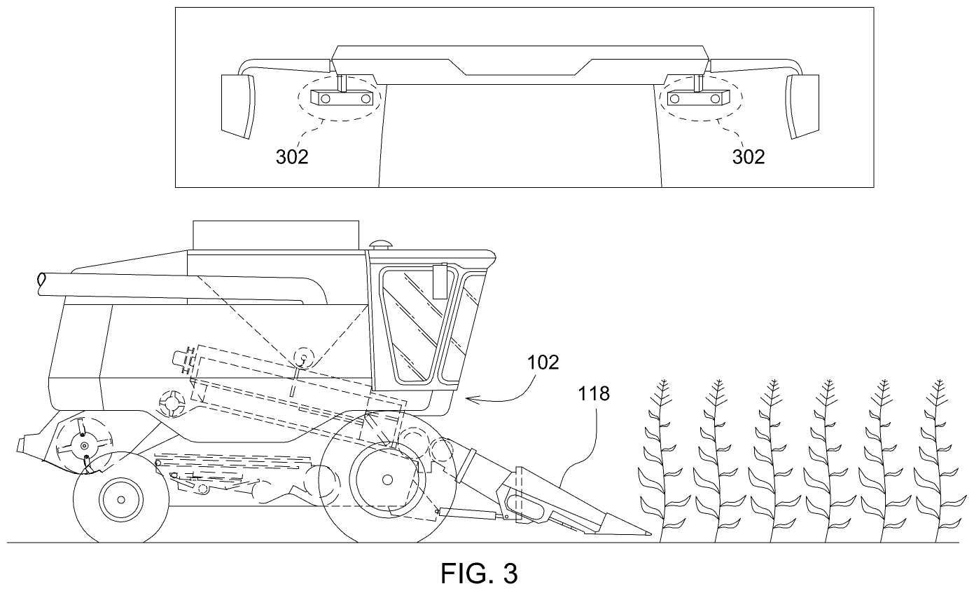

FIG. 3 shows an example work machine 300 (e.g., grain harvesting machine 102) that includes a plurality of optical sensors 302 (which may include image capture sensors 180). In some examples, the work machine 300 may include one or more optical sensors 302 such as one or more cameras (e.g., optical or visual radiation cameras or red, green, blue (RGB) cameras), LiDAR sensors, radar sensors (e.g., long-range terahertz radar, mm wave radar, ultra wideband radar, frequency-modulated continuous wave radar (FMCW), ground penetrating radar), ultrasonic sensors, thermal sensors (e.g., a thermal cameras), stereo cameras, laser vibrometers, infrared nuclear magnetic resonance (NMR) cameras, infrared short-wave infrared (SWIR) cameras, infrared terahertz sensors, three-dimensional sensors, and three-dimensional cameras, as well as combinations thereof, among other types of sensors operable to capture or generate one or more images or data corresponding to the one or more images of the field of view.

As discussed below, in some examples, one or more processors such as the controller 104 and/or the processor 206 and the optical sensor 302, may be configured to at least in part evaluate captured information from the optical sensor 302, such as, for example, on a pixel level, or based on a collection or area(s) of pixels, among other bases for evaluation. Such an evaluation may be based, for example, at least in part, on either or both a color or level of light present or not present in an area(s) or pixels in the captured information, as well as associated depth information.

Examples shown herein describe methods and systems for monitoring a portion of an agricultural field to determine whether non-crop objects may interfere with operation of a work machine (e.g., grain harvesting machine 102). As described above field condition monitoring may be beneficial to determine whether there are non-crop objects that may inhibit operation of a work machine. In some examples, the work machine may deploy monitoring techniques and methods to determine whether there are non-crop objects disposed directly in front of a header and/or between a header and a combine, which may obstruct work machine 300 operation.

FIG. 3 shows an example work machine 300, which includes an optical sensor 302 such as the image capture sensor 180. The optical sensor 302 may be positioned to monitor portions of a header such as the header 118, and at least a portion of crop material in front of the header 118. The optical sensor may be positioned to sense and locate non-crop objects disposed on the ground between the header 118 and the harvesting machine 102. For example, the optical sensor may be disposed on a forward portion of the work machine 300 and positioned to detect an area between the header 118 and rearward portions of the work machine 300. In other examples, the optical sensor may be disposed separately from the work machine 300 such as on an arial drone and communicatively coupled to the work machine 300 and positioned to detect an area between the header 118 and rearward portions of the work machine 300. Although examples illustrated herein include detection of non-crop objects, in some examples, one or more processors may be configured to monitor commodity such as grain disposed in detect header loss on the ground under/behind 118 with the location 302 which may also indicate potential grain loss as described regarding image capture sensors 180 described above.

Examples shown herein describe methods and systems for monitoring a portion of the work machine 300 to determine work machine conditions. Work machine condition monitoring may be beneficial to determine if machine conditions such as wear may prompt action such as repair or operational adjustment.

As described above, the sensor data may be received from one or more sensors for determining work machine conditions. For example, the one or more sensors may be optical sensors 302, vibration sensors, or thermal sensors. In some examples, an optical sensor 302 may be positioned to sense and locate work machine conditions, such as combine header conditions.

In some examples, the one or more sensors may include a plurality of sensors positioned to determine a condition of one or more work machine components. For example, the work machine components may be one or more reel and crop gathering components such as, row unit snouts, augers, conveyer belts, divider/points, severing devices (e.g., blades, cutterhead, sections, knives or guards), fluid delivery hoses and reservoirs, harnesses, lights and indicators. As such, in some examples the data is received for determining one or more work machine operation conditions of a combine header based at least in part on one or more components. In such examples, the sensor data may be data that either alone or in combination with one or more other portions of data is suitable to determine characteristics of one or combine header components. For example, the data may be visual data, thermal data, vibration data, or GPS data. In such examples, the data may be used to determine whether components of a combine header are in various conditions (e.g., operational, compromised, non-operational, etc.).

In some examples, operational conditions may include conditions that include light component wear and do not affect operation. Compromised conditions may include conditions that may compromise work component operation over time. Non-operational conditions may include conditions that may affect the quality of operation of the work machine at a given time or cause further compromise to the work machine. Each of the conditions may prompt a unique response from the one or more processors of the work machine. In some examples, one or more processors may indicate the one or more conditions through an alert such as a display and/or an audio alert. The conditions described above are example conditions, and one or more other conditions may be sensed by the determined by the processor.

In some examples, data such as temperature data, vibration data, and speed data may be used to determine specific component conditions (e.g., component wear or failure). For example, sensed data regarding, heat may be an indication of friction, rubbing, component failure (e.g., bearing, stall or slip, material binding, build-up, or accumulation on top of or under belt). In some examples, heat dissipation in the form of heat radiation and/or waves may be detected and may be determined to indicate particle discharge, oil, lubricant or fluid spray/drip/pooling. In some examples, the heat dissipation may be detected from various components (e.g., bearing, stall or slip, material binding, build-up, or accumulation on top of or under belt).

In some examples, the sensor data may be utilized and/or combined to increase accuracy of condition recognition. For example, certain types of combine conditions may cause unique vibrational patterns for a work machine when the work machine is in operation. In such examples, optical data and vibration data may be combined to identify and verify the presence and characteristics of conditions of the combine and/or other portions of the work machine.

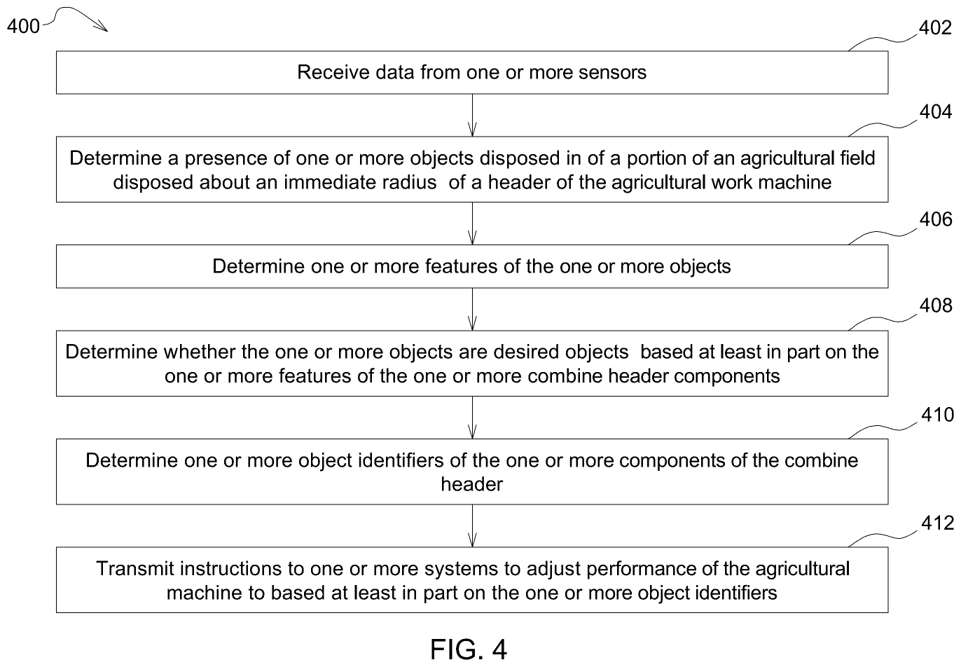

FIG. 4 is a flow chart showing example steps 400 for monitoring a portion of an agricultural field. The process may be implemented by a system for monitoring a portion of an agricultural field, which may include one or more processors such as the controller 104 and the processor 206.

At 402 in the example process shown in FIG. 4, the one or more processors receive sensor data from one or more sensors configured to transmit sensor data to the one or more processors. As described above, the sensor data may be received from the one or more sensors for determining work machine operation conditions. For example, one or more sensors may be optical sensors (e.g., camera, infrared camera, etc.), vibration sensors, or thermal sensors. In some examples where the data is received for determining objects are in a desired range of a combine header, the sensor data may be data that either alone or in combination with one or more other portions of data is suitable to determine characteristics of one or more objects. In such examples, the data may be processed to determine whether objects disposed about a combine header are particular objects such as desired objects (e.g., crop objects) or non-crop objects. For example, non-crop objects may be objects not to be ingested into a combine such as rocks, debris (e.g., sticks/tree branches, fencing materials, and dirt), or tools. In some examples, the sensor data may be combined to increase accuracy of object recognition. For example, certain types of debris may cause unique vibrational patterns for a work machine when the work machine interacts with the debris by ingesting or overrunning the debris. In such examples, optical data and vibration data may be combined to identify and verify the presence and characteristics of objects such as non-crop objects.

At 404 in the example process shown in FIG. 4 the one or more processors receive an indication of a presence of one or more objects disposed in a portion of an agricultural field disposed about a determined area such as a predetermined distance in a forward direction of a header of the work machine (e.g., 50 m, 30 m, 5 m). In some examples, the determined area may be an area in a side direction with respect to the direction of operational movement (e.g., 50 m, 30 m, 5 m). In example processes where objects are detected in the determined area, the one or more sensors such as optical sensors may transmit data indicating that there are one or more objects in a desired vicinity of the work machine 300. For example, the desired vicinity may be a radius of about 0-100 m. In some examples as described above, the radius may include a space in a forward direction of a combine header and a space between a combine header and a work machine.

At 406 in the example process shown in FIG. 4 the one or more processors determine one or more features of the one or more objects. For example, the one or more processors may analyze optical data that indicates certain outlines of non-crop objects and compare the data to a data set in a database. In some examples, the database may include sample crop objects and non-crop objects for comparison. In some examples, the objects may be analyzed by a machine learning process such as a computer vision model that may determine what features the object includes. Example features may include shape size, color, temperature, or other relevant features to determining a type of object (e.g., texture, reflectance, orientation, position, arrangement, etc.).

At 408 in the example process shown in FIG. 4 the one or more processors determine whether the one or more objects are desired or non-desired objects based at least in part on the one or more features of the one or more combine header components. For example, the one or more processors may determine through an algorithm or a machine learning process that the objects may be crop, commodity, or ground material such that the object is determined to be a desired object that may pass through the combine under normal operating conditions. In some examples, the processor may determine that the objects are non-desired objects such as rocks, debris, tools, or other non-crop objects.

At 410 in the example process shown in FIG. 4, the one or more processors determine one or more object identifiers of the one or more objects. For example, the one or more processors may determine through machine learning or comparison with one or more objects in an object library that an object includes an identifier. Identifiers may include a shape, color, size, texture, temperature or combination of features that is associated with the object. In such examples the one or more processors may determine the object has an identifier that may indicate the object is a desired object or a crop object or a non-crop object.

In some examples, the one or more processors may be configured to classify the one or more objects. For example, the one or more processors may classify the object as a non-crop object, a crop object, a non-desired object, a desired object, or other suitable classifications. The classification may be based on the one or more object identifiers, other features, or combinations of features. For example, an object may be classified according to sensed aspects such as an optical identifier, a thermal signature, and a vibration signature.

At 412 in the example process shown in FIG. 4 the one or more processors transmit instructions to one or more systems to adjust performance of the agricultural machine based at least in part on the one or more object identifiers and classification of the one or more objects. For example, the one or more processors may determine that the one or more objects are non-crop objects that are undesirable for ingestion into the combine. In such examples, the one or more processors may send instructions to an actuator to stop an ingestion movement of the work machine 300. The instructions may also be sent to systems such as electronic actuators or engine controls of the work machine to cause the work machine to slow down or stop during a harvesting operation.

In some examples, the one or more processors may determine a predicted interaction of the one or more objects based at least in part on classification information. For example, the classification information may indicate that objects may be objects that are likely to cause damage to the work machine if ingested. In other examples, the one or more processors may predict that the objects may unbalance or obstruct the work machine's path. As such the one or more processors may account for variations in operation based on the detected objects and related predictions. In some examples, information may be transmitted from the one or more processors to a central processor such as a central server, or a remote server, which may process data such as sensed data and for operation and prediction of one or more work machines.

In some examples, the one or more processors may be configured to receive a field location of the of the one or more objects. In such examples, the one or more processors may use proximity data such as relative proximity, mapping, or GPS data to determine a location where the one or more objects are detected. The location data may be utilized to determine one or more future predicted object locations based at least in part on the sensor data. In some examples, the one or more processors may send the data to a central server or analyze the data on an internal processor. In some examples, the one or more processors may use the data to determine where objects are and correlate the objects with particular field locations for future operations. In some examples the data can also be correlated with places where objects maybe more likely to show up such as at a field boundary or at a road crossing. In such examples, the one or more processors may utilize logic-based analysis and/or machine learning to determine a course of action and/or predict future object encounters.

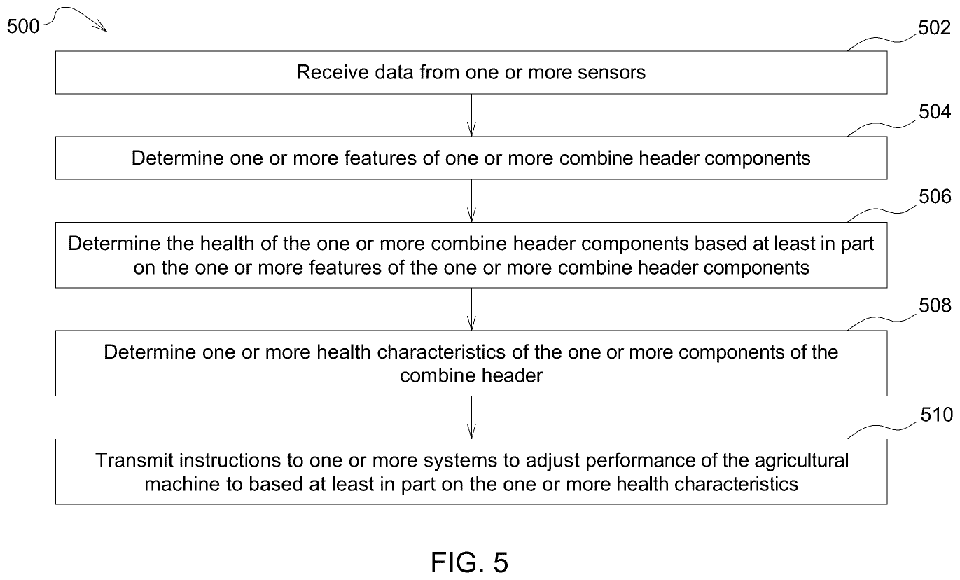

FIG. 5 is a flow chart showing example steps 500 for monitoring a portion of the work machine 300. The process may be implemented by a system for monitoring a portion of the work machine 300, which may include one or more processors such as the controller 104 and the processor 206.

At 502 in the example process shown in FIG. 5, the one or more processors receive sensor data from one or more sensors configured to transmit sensor data to the one or more processors. The sensor data may be data from a sensor such as an optical sensor such as a camera, an infrared camera, or some other optical sensor. In some examples where the data is utilized to determine a condition of one or more features of a combine header, the sensor data may be data that is suitable to determine various hardware features either alone or in combination with one or more other portions of data.

In some examples, the data may be thermal data, vibration data, or GPS data used to determine whether components have abnormalities such as optical or vibrational abnormalities. For example, abnormalities may be attributes that indicate the work machine, or portions of a work machine such as a header are in a condition outside of initial working conditions. This may include damage, misalignment, missing components, displacement or other distinguishing characteristics from a standard operating condition. In some examples, nonstandard operating conditions may include conditions where two or more work machine components are contacting each other that are not contacting each other at work machine assembly (e.g., Reel with a hose or structure . . . auger with structure or wear/skid plate). For example, a header may have a bent component that is optically distinct from a non-bent component and causes vibration modes different from a non-bent component.

In some examples, the sensor data may be combined to more accurately determine a condition. For example, certain components may cause specific vibrational patterns when distorted or bent to abut particular other portions of the work machine. In such examples, optical data, and vibration data may be combined to identify and verify the presence of machine abnormalities.

At 504 in the example process shown in FIG. 5, the one or more processors receives an indication of a presence of one or more abnormalities on a work machine. In examples where abnormalities are detected on the work machine, the one or more sensors such as optical sensors may transmit data indicating that there are one or more abnormalities on the work machine. Abnormalities may be any condition that deviates from a determined typical operating condition. For example, a surface of the machine may be bent, causing visual indication, vibration, or other conditions that deviate from standard working conditions. In such examples, the sensors may transmit visual, vibrational, or other condition data to a processor to determine a physical nature of the abnormalities.

At 506 in the example process shown in FIG. 5, the one or more processors determine one or more features of the one or more components of a header of a work machine. For example, the one or more processors may analyze optical data that determines certain visual characteristics of work machine components based at least in part on reference images. In other examples, the work machine components may be analyzed at least in part by machine learning to determine features of the visual characteristics. In some examples, features may include shape size, color, orientation, geometry, profile, temperature, heat signature, or other relevant features related to determining a condition of a portion of a work machine.

In some examples, the one or more processors use machine health data correlated to machine operating conditions. The machine health data may include examples of machine components in various conditions and states of repair for comparison to components in operation. For example, component health data may include data categories such as blade health data, surface data, and hose health data. In some examples, component health data may include cutting apparatus health, crop gathering component orientation and geometry position health, surface profile data, fluid delivery system integrity, etc.

At 508 in the example process shown in FIG. 5, the one or more processors determine whether the work machine characteristics are desired work machine characteristics (e.g., work machine health characteristics) based at least in part on the one or more features of the one or more combine header components. For example, the one or more processors may determine through an algorithm or a machine learning process that the components may exhibit one or more abnormal characteristics such that the one or more abnormal characteristics may be classified or determined to be a desired characteristic or an un-desired characteristic.

At 510 in the example process shown in FIG. 5 the one or more processors transmit instructions to one or more systems to adjust performance of the work machine based at least in part on the one or more feature characteristics. For example, the one or more processors may determine that the one or more features are abnormalities that are undesired (e.g., machine health characteristics indicating abnormalities). In such cases, the one or more processors may send instructions to a combine actuator to halt propulsion to avoid ingestion and/or to disengage a gathering system such as a header or attachment that supports the work vehicle in order to avoid presenting a threshing or processing system of the work machine with undesired materials.

The instructions may also be sent to systems such as motors or ECU of the work machine to cause the work machine to slow down or stop during a harvesting operation to prevent unwanted operation conditions and allow for the conditions to be addressed.

In some examples, the one or more processors may determine a future health of a work machine, based at least in part on feature classification information. For example, the classification information may include baseline component features such as blade shape, hose temperature, and work machine vibration modes. In some examples, the one or more processors may predict certain further component abnormalities based on previous component abnormalities. For example, the one or more processors may predict that a bent blade may deflect debris such that the debris may further bend other components of the work machine. As such one or more processors may account for variations in operation based on the predictions. In some examples, information may be transmitted from the one or more processors to a central processor such as a central server, or a remote server, which may process data such as sensed data and for operation and prediction of one or more work machines.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

The foregoing description and examples have been set forth merely to illustrate the disclosure and are not intended as being limiting. Each of the disclosed aspects and embodiments of the present disclosure may be considered individually or in combination with other aspects, embodiments, and variations of the disclosure. In addition, unless otherwise specified, none of the steps of the methods of the present disclosure are confined to any particular order of performance. Modifications of the disclosed embodiments incorporating the spirit and substance of the disclosure may occur to persons skilled in the art and such modifications are within the scope of the present disclosure. Furthermore, all references cited herein are incorporated by reference in their entirety.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures but can encompass structures that are reasonably close approximations.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Although systems and methods for seed firming have been disclosed in the context of certain embodiments and examples, this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying modes of systems and methods for seed firming. The scope of this disclosure should not be limited by the particular disclosed embodiments described herein.

Certain features that are described in this disclosure in the context of separate implementations can be implemented in combination in a single implementation. Conversely, various features that are described in the context of a single implementation can be implemented in multiple implementations separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various embodiments described and the appended claims. Further, the disclosure herein of any particular feature, aspect, method, property, characteristic, quality, attribute, element, or the like in connection with an embodiment can be used in all other embodiments set forth herein. Any methods disclosed herein need not be performed in the order recited. Depending on the embodiment, one or more acts, events, or functions of any of the algorithms, methods, or processes described herein can be performed in a different sequence, can be added, merged, or left out altogether (e.g., not all described acts or events are necessary for the practice of the algorithm). In some embodiments, acts or events can be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each embodiment. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some embodiments may be performed using the sequence of operations described herein, while other embodiments may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described herein should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. Certain figures are drawn and/or shown to scale, but such scale should not be limiting, since dimensions and proportions other than what are shown are contemplated and are within the scope of the embodiments disclosed herein. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

The methods disclosed herein may include certain actions taken by a practitioner; however, the methods can also include any third-party instruction of those actions, either expressly or by implication. For example, actions such as “positioning an electrode” include “instructing positioning of an electrode.”

The ranges disclosed herein also encompass any and all overlap, subranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 1 V” includes “1 V.” Phrases preceded by a term such as “substantially” include the recited phrase and should be interpreted based on the circumstances (e.g., as much as reasonably possible under the circumstances). For example, “substantially perpendicular” includes “perpendicular.” Unless stated otherwise, all measurements are at standard conditions including temperature and pressure.

In summary, various embodiments and examples of systems and methods for seed firming has been disclosed. Although the systems and methods for seed firming have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein but should be determined only by a fair reading of the claims that follow.

1. A system for monitoring a portion of an agricultural field during operation of an agricultural work machine, the system comprising:
one or more processors;
one or more sensors configured to transmit sensor data to the one or more processors;
a memory device coupled to the one or more processors, the memory device including instructions that when executed by the at least one or more processors cause the one or more processors to:
determine a presence of one or more objects disposed in of a portion of an agricultural field disposed about a vicinity of a header of the work machine;
determine one or more features of the one or more objects;
determine whether the one or more objects are desired objects based at least in part on the one or more features of the one or more objects;
determine one or more object identifiers of the one or more objects; and
transmit instructions to one or more systems to adjust performance of the agricultural machine based at least in part on the one or more object identifiers.

2. The system of claim 1, wherein the one or more sensors comprises an optical sensor.

3. The system of claim 1, wherein the one or more processors are further configured to classify the one or more objects.

4. The system of claim 3, wherein the one or more processors are further configured to determine a predicted interaction of the one or more objects based at least in part on classification information.

5. The system of claim 1, wherein the one more sensors comprise a vibration sensor and an optical sensor, and wherein the processor is configured to determine one or more objects based at least in part on optical data and vibration data from the vibration sensor and the optical sensor.

6. The system of claim 1, wherein the vicinity comprises a ground portion of the agricultural field between the header and the work machine.

7. The system of claim 1, wherein the vicinity comprises a ground portion of the agricultural field in front of the header with respect to a direction of travel of the work machine.

8. The system of claim 1, wherein the processor is configured to receive a field location of the of the one or more objects.

9. The system of claim 1, wherein the processor is configured to transmit sensor data to a central processor, wherein the central processor is configured to determine one or more future predicted object locations based at least in part on the sensor data.

10. The system of claim 9, wherein the processor is configured to determine a predicted object based at least in part on a received field location of the work machine.

11. The system of claim 10, wherein the received field location is a field boundary.

12. The system of claim 9, wherein the central processor is configured to transmit the one or more future health conditions to the one or more processors.

13. The system of claim 12, wherein the one or more processors are configured to provide operational instructions to one or more systems of the work machine.

14. A method for monitoring a portion of an agricultural field during operation of an agricultural work machine, the method comprising:
receiving data from one or more sensors;
determining a presence of one or more objects disposed in of a portion of an agricultural field disposed about a vicinity of a header of the work machine;
determining one or more features of the one or more objects;
determining whether the one or more objects are desired objects based at least in part on the one or more features of the one or more objects;
determining one or more object identifiers of the one or more objects; and
transmitting instructions to one or more systems to adjust performance of the work machine to based at least in part on the one or more object identifiers.

15. The method of claim 14, wherein the data from the one or more sensors comprises optical sensor data.

16. The method of claim 14, further comprising classifying one or more objects determined to be present.

17. The method of claim 16, further comprising determining a predicted interaction of the one or more objects based at least in part on classification information.

18. The method of claim 14, wherein the vicinity comprises a ground portion of the agricultural field between the header and the work machine.

19. The method of claim 14, wherein the vicinity comprises a ground portion of the agricultural field in front of the header with respect to a direction of travel of the work machine.

20. The method of claim 14, further comprising receiving a field location of the of the one or more objects.

21. The method of claim 14, further comprising transmitting sensor data to a central processor, wherein the central processor is configured to determine one or more future predicted object locations based at least in part on the sensor data.

22. The method of claim 14, further comprising determining a predicted object based at least in part on a received field location of the work machine.

23. The method of claim 14, further comprising receiving the one or more future health conditions from the central processor.
